(19) United States
(12) Patent Application Publication
(10) Pub. No.: US 2022/0156989 A1
(43) Pub. Date: May 19, 2022

(54) METHOD AND SYSTEM FOR OUTPUTTING CHARACTER, ELECTRONIC DEVICE, AND STORAGE MEDIUM

(71) Applicant: BOE Technology Group Co., Ltd., Beijing (CN)

(72) Inventor: Gao JI, Beijing (CN)

(21) Appl. No.: 17/528,024

(22) Filed: Nov. 16, 2021

(30) Foreign Application Priority Data
Nov. 19, 2020 (CN) 202011308022.6

(51) Int. Cl. G06T 11/20; G06T 1/60

(52) U.S. Cl. CPC G06T 11/203; G06T 1/60

(57) ABSTRACT

Provided is a method for outputting a character. The method includes: acquiring a character data stream; acquiring a character picture by drawing character data in the character data stream based on a size of a target picture and a number of target characters contained in the target picture; generating, according to a target display frequency, a character video based on the character picture; and outputting the character video.

### CROSS-REFERENCE TO RELATED APPLICATION

This application claims priority to Chinese Patent Application No. 202011308022.6, filed on Nov. 19, 2020, the disclosure of which is herein incorporated by reference in its entirety.

### TECHNICAL FIELD

The present disclosure relates to the field of data processing technologies, and in particular to a method and a system for outputting a character, an electronic device, and a storage medium.

### BACKGROUND

Character information is generally displayed statically. However, when the amount of information is relatively large, a user may need to turn pages, which is inconvenient for the user to use.

### SUMMARY

The present disclosure provides a method and a system for outputting a character, an electronic device, and a storage medium.

In a first aspect of embodiments of the present disclosure, a method for outputting a character is provided. The method includes:

acquiring a character data stream;

acquiring a character picture by drawing character data in the character data stream based on a size of a target picture and a number of target characters contained in the target picture;

generating, according to a target display frequency, a character video based on the character picture; and

outputting the character video.

In a second aspect of the present disclosure, an electronic device is provided. The electronic device includes:

at least one processor; and a volatile or nonvolatile memory configured to store at least one instruction executable by the processor,

wherein the at least one processor, when executing the at least one instruction, is caused to perform the method as defined in the first aspect.

In a third aspect of the present disclosure, a system for outputting a character is provided. The system includes:

an electronic device as defined in the second aspect;

a terminal device configured to output a character data stream to the electronic device; and

a display apparatus configured to display a character video output by the electronic device.

In a fourth aspect of the present disclosure, a non-transitory computer-readable storage medium storing at least one instruction therein is provided, wherein the at least one instruction, when loaded and executed by a processor of an electronic device, causes the electronic device to perform the method for outputting the character as defined in the first aspect.

### BRIEF DESCRIPTION OF THE DRAWINGS

FIG. 1 shows a schematic flowchart of an exemplary method according to an embodiment of the present disclosure;

FIG. 2 shows a schematic flowchart of an exemplary method according to an embodiment of the present disclosure;

FIG. 3 shows a more specific schematic diagram of a hardware structure of an electronic device according to an embodiment of the present disclosure; and

FIG. 4 shows a schematic structural diagram of an exemplary system according to an embodiment of the present disclosure.

### DETAILED DESCRIPTION

For clearer descriptions of the objects, technical solutions, and advantages of the present disclosure, the present disclosure is described in further detail hereinafter in combination with specific embodiments and with reference to the accompanying drawings.

It should be noted that unless otherwise defined, technical terms or scientific terms used in the present disclosure should have the ordinary meanings as understood by one having ordinary skill in the art to which the present disclosure belongs. The terms “First,” “second,” and the like in the present disclosure are not intended to indicate any order, quantity, or importance, but are merely configured to distinguish different components. The terms “include” or “comprise”, and the like mean that the element or object preceding the word includes the element or object and its equivalents listed after the word, but does not exclude other elements or objects. The terms “connected” or “coupled”, and the like are not limited to a physical or mechanical connection, and may include an electrical connection that may be direct or indirect.

In the related art, a static text is displayed on a display or a related device, which is generally achieved by calling a function (for example, a print function) in an underlying library of the device, thus realizing the text display. In the case that a multi-line text needs to be displayed in real time, a device display function may be called in response to acquiring the multi-line text. However, there is a problem in the related art, that is, the display speed is too fast and exceeds the speed capable of being captured by human eyes, such that it is hard for a user to see real-time characters displayed on the device clearly.

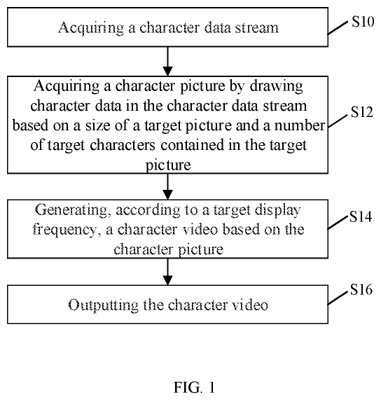

FIG. 1 shows a schematic flowchart of an exemplary method according to an embodiment of the present disclosure. Referring to FIG. 1, a method for outputting a character includes:

S10: acquiring a character data stream:

S20: acquiring a character picture by drawing character data in the character data stream based on a size of a target picture and a number of target characters contained in the target picture:

S30: generating, according to a target display frequency, a character video based on the character picture; and

S4: outputting the character video.

In the method for outputting the character according to the present disclosure, the character picture can be acquired by drawing the character data in the character data stream, and then a character video can be acquired by forming the character picture, such that a user can acquire character information by playing the character video, thereby improving user experience. In addition, in the method for outputting the character according to the present disclosure, the character video is formed by the size of the target picture capable of adapting to the capture speed of human eyes, the number of target characters contained in the target picture, and the target display frequency, such that a display speed of the real-time character stream is reduced and the character video adapting to the capture speed of human eyes is formed, thereby ensuring a better character display effect.

In addition, with the development of Internet of Things, more and more terminal devices have been developed, and a wider application market has been formed, such as building outdoor advertising machines, supermarket shelf signs, and meteorological environment observers. These devices need operation and maintenance after being deployed. To improve the efficiency of operation and maintenance, it is necessary to supervise operation conditions of the terminal devices to perform maintenance in time and ensure the availability of the terminal devices. When the device is maintained, it is generally to view real-time logs of the device to acquire the operation condition of the device. A general way to display the real-time log is to print log data through a console window, but this way has two disadvantages: firstly, the experience of browsing by the user is very poor, and secondly, the log review is not facilitated.

Therefore, by adopting the method for outputting the character according to the embodiment of the present disclosure, the log data can be generated into a character video, such that a user can browse conveniently. In addition, the character video can be sent to a real-time video service, such that a user can call the character video from the real-time video service for viewing and can review the character video at any time.

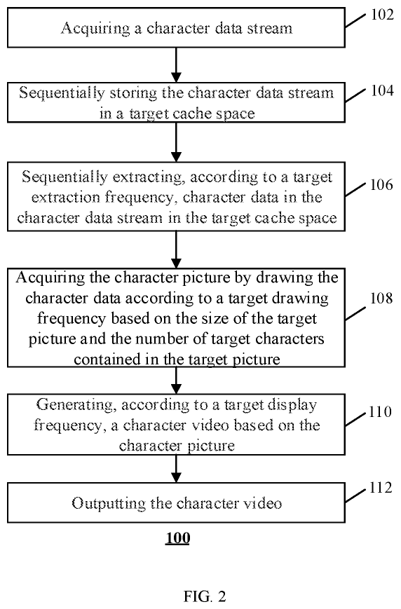

FIG. 2 shows a schematic flowchart of an exemplary method according to an embodiment of the present disclosure.

As shown in FIG. 2, the method for outputting the character 100, for example, may be applied to a server having a central processing unit (CPU), a storage device, and a network card device. The server includes a personal computer, a supercomputer, a network computer, a virtual server, an embedded computer, and the like. In some embodiments, the server is a cloud server. The method 100 may include the following processes.

In 102, a character data stream may be acquired.

Generally, the character data stream is a data stream containing various characters, and is a data stream generated by a program or programs continuously calling an underlying output function, and these data streams are output to a network or standard output. The method for acquiring the character data stream includes, but is not limited to, acquiring the data stream from the network through a network interface, and acquiring the data stream in the standard output through standard output redirection.

In a computer system, a standard output device is generally referred to as a screen display, and the standard output redirection means that the data output to the display is redirected and output to other devices. For example, in a Linux system, in the case that command echo 123 is executed, this command may display “123” on the display; in the case that echo 123>a.txt “123” is executed, “123” may be written into a disk file a.txt. The data that should have been output to the display is redirected and output to a disk, that is, the standard output is redirected. In addition, the standard output may also be redirected to the network card device and thus sent to the network.

The standard output redirection in the embodiment of the present disclosure may mean that the data output by programs to the display is redirected and output to other devices, such as a memory device, such that the data output by the programs can be processed.

In some embodiments, the character data stream may be a log data stream acquired by the cloud server from the terminal device (for example, an Internet of Things device).

In 104, the character data stream may be sequentially stored in a target cache space.

The target cache space may be a part of computer memory, and the character data stream may be cached in the space in a sequence. In some embodiments, character data in the character data stream may be counted and sequentially stored in the computer memory based on a specific number of characters in each line as a unit.

In some embodiments, sequentially storing the character data stream in the target cache space includes:

allocating a target storage space to the target cache space, and sequentially storing the character data stream in the target storage space, for example, developing a continuous storage space in the computer memory as the target storage space to cache the character data stream, wherein a size of the target storage space may be set to several MB or several GB, such as 100 MB;

continuing to allocate, in response to the character data stream that needs to be stored in the target cache space exceeding a storage capacity of the target storage space, that is, a capacity of caching the character data stream exceeding the storage capacity of the target storage space, a first incremental storage space to the target cache space, and sequentially storing a part of the character data stream that exceeds the capacity in the first incremental storage space, wherein, for example, the size of the first incremental storage space may be the same as the target storage space, such as 100 MB, which means that when the storage capacity of the target storage space is insufficient, the target cache space may be increased to twice the original size, that is, 200 MB;

continuing to allocate, in response to the character data stream that needs to be stored in the target cache space exceeding a sum of storage capacities of the target storage space and the first incremental storage space, a second incremental storage space to the target cache space again, and sequentially storing a part of the character data stream that exceeds the storage capacities of the target storage space and the first incremental storage space in the second incremental storage space, wherein, for example, the size of the second incremental storage space may be the same as the sum of the storage capacities of the target storage space and the first incremental storage space, such as 200 MB, which means that when the sum of the storage capacities of the target storage space and the first incremental storage space is insufficient, the target cache space may be increased twice again, that is, 400 MB: and

repeating the foregoing process of continuing to allocate an incremental storage space in response to the capacity of caching the character data stream exceeding the sum of the storage capacities of the target storage space and the allocated incremental storage space, and stopping, in response to a storage capacity of the storage space allocated to the target cache space reaching a storage capacity threshold, allocating an incremental storage space to the target cache space (for example, ½ of an available space of the computer memory).

Through the above embodiments, when the character data stream needing to be stored in the target cache space exceeds the storage capacity of the storage space allocated to the target cache space, the target cache space is increased until the increased capacity reaches the storage capacity threshold, thereby solving the problem of insufficient storage capacity which may occur in the target cache space.

In some embodiments, sequentially storing the character data stream in the target cache space further includes:

allocating a preliminary storage space to the target cache space, wherein the preliminary storage space may be configured to perform preliminary processing on the acquired character data stream, for example, to perform statistics and segmentation on the character data: and

counting the character data in the character data stream in the preliminary storage space, and segmenting the character data according to a preset rule. For example, the amount of character data (that is, the number of characters) in the acquired character data stream may be counted at first, assuming that there are I000 characters, then the 1000 characters may be segmented, and the preset rule for segmenting the character data may be determined based on a size of a picture, the maximum number of characters contained in the picture, a font size, a target extraction frequency, and a target drawing frequency. For example, assuming that based on a size of a character picture, the area at the periphery of the character picture that needs to be left blank, and a font size, one character picture is capable of containing 200 characters at most, then 1000 characters may be segmented into 5 parts at first, and based on values of a target extraction frequency and a target drawing frequency, 20 characters may be drawn each time one character picture is drawn, and then 200 characters in the character picture may be further segmented into 10 parts.

Then, each segmented piece of character data may be sequentially stored in the target storage space for subsequent picture drawing.

In some embodiments, the method for determining that the storage capacity of the target storage space is insufficient may be that the storage capacity of the target storage space is exceeded for a plurality of times (for example, 3 times), to avoid reducing the processing efficiency due to frequent application of a large memory space.

For example, after the character data is segmented in the preliminary storage space, when the segmented character data is sent to the target storage space, the target storage space may overflow. In this time, the overflowed data is stopped from being sent to the target storage space, and the data is temporarily stored in the preliminary storage space with the number of overflows plus 1. After a period of time (set according to needs), the data is sent to the target storage space again. In the case that the target storage space still overflows, the data is continued to be temporarily stored in the preliminary storage space with the number of overflows plus 1, until the number of overflows meets a set value (for example, 3), and then the number of overflows is cleared to zero and the target storage space is increased. In some embodiments, the method for outputting the character 100 further includes:

sequentially storing, in response to the storage capacity of the storage space allocated to the target cache space reaching the storage capacity threshold, the character data stream of a set ratio (for example, ½) in the target cache space in another storage device. Another storage device is a device other than the target device.

In this way, when an upper limit of the target cache space is reached, the character data stream of the set ratio in the target cache space is output to another storage device, such as a high-performance hard disk and a network storage service, such that the space of the data storage device (for example, the computer memory) is not excessively occupied by the character data stream, thereby ensuring the normal operation of the data storage device.

In 106, the character data in the character data stream in the target cache space may be sequentially extracted according to the target extraction frequency.

In this process, the character data stream in the target cache space may be sequentially processed based on a specific target extraction frequency. In some embodiments, a value of the target extraction frequency may range from 20 to 40 frames/s. This frequency is a frequency better matched with the capture speed of human eyes, which can ensure that the character video generated after data extraction is capable of adapting to the capture speed of the human eyes. In particular, the value of the target extraction frequency may be 30 frames/s, which can be better matched with the capture speed of the human eyes.

In step 108, a character picture may be acquired by drawing the character data according to a target drawing frequency based on the size of the target picture and the number of target characters contained in the target picture.

In this process, the size of the target picture may be set according to needs or a resolution of the display, such as 1024p×768p. The number of the target characters contained in the target picture may also be set according to needs.

In this process, the character picture may be acquired by drawing the character data according to a specific target drawing frequency. In some embodiments, a value of the target drawing frequency may range from 20 to 40 frames/s. This frequency is a frequency better matched with the capture speed of the human eyes, which can ensure that the character video generated after picture drawing is capable of adapting to the capture speed of the human eyes. In particular, the value of the target drawing frequency may be 30 frames/s, which can be better matched with the capture speed of the human eyes.

In some embodiments, acquiring the character picture by drawing character data in the character data stream based on the size of the target picture and the number of target characters contained in the target picture includes:

determining the size of the target picture, for example, 1024p×768p;

determining, based on the size of the target picture and a font size of a target character, the number of target characters contained in the target picture, wherein for example, when the font is larger, the number of characters in each line may be less, and when the font is smaller, the number of characters in each line may be more, and thus, according to different font sizes, the number of target characters contained in the target picture may also be different, and the number of target characters contained in the target picture needs to be determined based on the size of the target picture and the font size of the target character; and

drawing, according to a preset arrangement rule (for example, an arrangement order from left to right and top to bottom), the character data that are sequentially extracted on the target picture with the font size.

In some embodiments, drawing, according to the preset arrangement rule, the character data that are sequentially extracted on the target picture with the font size includes:

determining, according to the preset arrangement rule (for example, the arrangement order from left to right and top to bottom) and the font size in combination with the size of the target picture, a target position of the character data on the target picture; and

drawing the character data at the target position on the target picture.

In some embodiments, the maximum number of characters (for example, 200 characters) capable of being contained in each target picture may be calculated based on the preset size of each target picture, and then based on the number of characters of the character data stream in the target cache space at the current moment and the maximum number of characters capable of being contained in each target picture, the characters needing to be drawn on each target picture may be further determined. Meanwhile, the maximum number of pictures needing to be drawn currently (for example, 200 characters) may also be determined, and according to the target drawing frequency, the number of characters contained in the target picture (for example, 10 characters) may be determined each time the picture is drawn, and then a relative position of the characters may be determined, to draw a character picture.

The relative position is the relative position of the characters on the picture when the picture is drawn. For example, 200 characters may be drawn on one picture at most, and according to the target drawing frequency, only 10 characters may be drawn each time the picture is drawn. Therefore, when the next picture is drawn, in addition to a blank area at the periphery of the picture (for example, 5 rows of pixels on the top edge and 4 columns of pixels on the left edge of the picture), it is also necessary to consider the position of 10 characters this time relative to the last 10 characters (for example, the 10 characters drawn last time are in the first and second lines of a non-blank area, and the 10 characters drawn this time are in the third and fourth lines).

It can be seen that when the pictures of the present disclosure are drawn, not every picture is filled with the characters. For example, the first picture only has the first line and the second line, and the second picture includes the first to fourth lines. By the way of gradually adding the characters to the picture, after the video is converted, a dynamic character display effect is achieved. In addition, this way can be matched with the viewing speed of the human eyes.

It can be seen that when the target drawing frequency is different, the number of characters on each character picture may be different, and the relative positions of two adjacent pictures also need to be considered, such that the final character video presented to the user is that the maximum amount of character data (for example, 200 characters) is completely displayed on one picture.

Optionally, to achieve a better display effect, the character position on the character picture and the target drawing frequency may be adjusted based on the display speed and the display position of the characters on a display device, thereby forming the character video.

In 110, the character video may be generated based on the character picture according to the target display frequency.

In this process, the character picture may be generated into the character video according to a specific target display frequency. In some embodiments, a value of the target display frequency may range from 20 to 40 frames/s, and the frequency is a frequency better matched with the capture speed of the human eyes, which can ensure that the generated character video is capable of adapting to the capture speed of the human eyes. In particular, the value of the target display frequency may be 30 frames/s, which can be better matched with the capture speed of the human eyes.

In some embodiments, generating, according to the target display frequency, the character video based on the character picture includes:

generating, with OpenCV or a multimedia processing tool, the character video based on the character picture according to the target display frequency.

For example, a VideoWriter object in the OpenCV may be configured to generate the character video, and by calling a write method and receiving the character picture, a video file in a specified format may be generated.

For another example, a multimedia processing tool (FFmpeg) program may be run to synthesize the character picture into the character video, such as ffmpeg −f image2−i/images/% d.jpg-vcodec libx264−r 25-b 200k test.mp4 is run, and picture files named 0.jpg, 1.jpg, and the like in an images folder in a current directory are synthesized into a test.mp4 video file.

In 112, the character video is output.

In this process, a display apparatus of the device may be configured to display the character video, such that the user can acquire character information by viewing the video, which optimizes the mode of acquiring the character information by the user.

In some embodiments, outputting the character video includes.

sending the character video to a real-time video service, to enable the display terminal to request to play the character video from the real-time video service through a webpage or a player.

The real-time video service is a service program on a computer and provides storage, play, pause, fast-forward, and playback functions of the character video. After the character video is uploaded to the real-time video service, the character video is stored in a real-time video service side. The display terminal may request the character video needing to be played in the real-time video service through the webpage, the player, or the like.

In some embodiments, the target extraction frequency, the target drawing frequency, and target display frequency are matched with each other.

In the method for outputting the character according to the embodiments of the present disclosure, by acquiring the real-time character data stream and caching the acquired character data stream, the character picture based on a time sequence is drawn based on characters in the acquired character data stream and acquiring time, and the character video is generated based on the character picture and can be sent to the real-time video service to achieve the effect of presenting the real-time character stream. The method for outputting the character according to the embodiments of the present disclosure can enhance the effect of data presentation by an application-level system and is convenient for a user to browse the character data.

In the method for outputting the character according to the embodiment of the present disclosure, after the character data stream is converted into the character video, functions such as real-time review, pause, and fast forward can be realized.

The method for outputting the character according to the embodiment of the present disclosure is not only applied to the viewing log data. Any real-time character data can be converted into a specific character video through this method, which gives the character data more presentation modes and achieves a better information dissemination effect.

It should be noted that the method according to the present disclosure may be executed by a single device, such as a computer or a server. The method of the present embodiment may also be applied in a distributed scenario, and be completed by a plurality of devices in mutual cooperation. In such a distributed scenario, one of the plurality of devices may only execute one or more steps in the method according to the present disclosure, and these plurality of devices interact with each other to complete the above method.

It should be noted that the particular embodiments of the present disclosure have been described. Other embodiments are within the scope of the following claims. In some cases, the actions or steps recited in the claims may be performed in a different order from those in the embodiments and still achieve desirable results. In addition, the processes described in the accompanying figures do not necessarily require the particular order shown, or sequential order, to achieve desirable results. In some embodiments, multitasking or parallel processing may also be optional or advantageous.

Based on the same inventive concept and corresponding to any of the above method embodiments, the present disclosure also provides an electronic device, including a memory, a processor, and a computer program stored on the memory and running on the processor. When the processor executes the program, the method for outputting the character 100 according to any one of the above embodiments is performed.

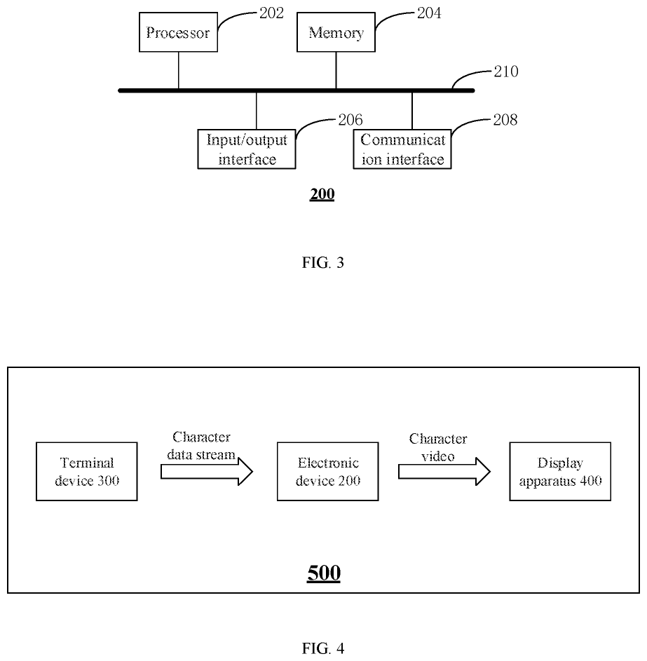

FIG. 3 shows a more specific schematic diagram of a hardware structure of an electronic device 200 according to an embodiment of the present disclosure. The device 200 may include: a processor 202, a memory 204, an input/output interface 206, a communication interface 208, and a bus 210. The processor 202, the memory 204, the input/output interface 206, and the communication interface 208 realize communication connection between each other in the device via the bus 210.

The processor 202 may be implemented by a general central processing unit (CPU), a microprocessor, an application-specific integrated circuit (ASIC), or one or more integrated circuits, and is configured to perform related programs to implement the method according to the embodiments of the present disclosure.

The memory 204 may be implemented by a read-only memory (ROM), a random-access memory (RAM), a static storage device, and a dynamic storage device. The memory 204 may store an operating system and other application programs. When the technical solutions according to the embodiments of the present disclosure are implemented by software or firmware, related program codes are stored in the memory 204 and called to be executed by the processor 202.

The input/output interface 206 is configured to connect an input/output module to realize information input and output. The input/output module may be configured in the device as a component (not shown in the drawings), and may also be externally connected to the device to provide corresponding functions. An input device may include a keyboard, a mouse, a touch screen, a microphone, various sensors, and the like, and an output device may include a display, a speaker, a vibrator, an indicator light, and the like.

The communication interface 208 is configured to connect a communication module (not shown in the drawings) to implement communication interaction between the device and other devices. The communication module may realize communication in a wired manner (such as a USB, a network cable, and the like), or a wireless manner (such as a mobile network, Wi-Fi, Bluetooth, and the like).

The bus 210 includes a circuit configured to transmit information between various components of the device (for example, the processor 202, the memory 204, the input/output interface 206, and the communication interface 208).

It should be noted that although only the processor 202, the memory 204, the input/output interface 206, the communication interface 208, and the bus 210 are shown in the above device, in a specific implementing process, the device may also include other components required for normal operation. In addition, those skilled in the art may understand that the above device may also only include the components necessary to implement the solutions of the embodiments of the present disclosure, with no need to include all the components shown in the drawings.

The electronic device according to the above embodiments is configured to implement the corresponding method for outputting the character 100 in any one of the foregoing embodiments and has the beneficial effects of the corresponding method embodiments, which is not be repeated here.

Based on the same inventive concept, the present disclosure also provides a system for outputting a character. FIG. 4 shows a schematic structural diagram of an exemplary system 500 according to an embodiment of the present disclosure. The system 500 includes:

an electronic device 200, wherein in some embodiments, the electronic device 200 may be a cloud server;

a terminal device 300 configured to output a character data stream to the electronic device 200, wherein in some embodiments, the terminal device 300 may be an Internet of Things device: and

a display apparatus 400 configured to display a character video output by the electronic device 200, wherein in some embodiments, the display apparatus 400 may be a server-side device with a display function, or in some embodiments, the display apparatus 400 may be an external device such as an outdoor large-screen advertising system.

The terminal device 300 may periodically upload the character data stream to the electronic device 200 in a wired or wireless manner.

In some embodiments, the display apparatus 400 may acquire and play the character video through a real-time video service.

Based on the same inventive concept and corresponding to any one of the above method embodiments, the present disclosure also provides a non-transitory computer-readable storage medium storing at least one computer instruction therein. The at least one computer instruction, when loaded and executed by a processor of a computer, causes the computer to perform the method for outputting the character 100 as defined in any one of the above embodiments.

The computer-readable storage medium according to the embodiments of the present disclosure includes both persistent and non-persistent and removable and non-removable storage mediums that may be implemented in any method or technology for storage of information. The information may be computer-readable instructions, data structures, program modules, or other data. Examples of the computer storage medium include, but are not limited to, a phase-change RAM (PRAM), a static random access memory (SRAM), a dynamic random access memory (DRAM), other types of random access memories (RAM), a read-only memory (ROM), an electrically erasable programmable read-only memory (EEPROM), a flash memory or other memory technologies, a compact disk read-only memory (CD-ROM), a digital versatile disk (DVD) or other optical storages, a magnetic cassette-type magnetic tape, a magnetic disk storage or other magnetic storage devices, or any other non-transmission mediums that can be configured to store information for access by a computing device.

The computer instructions stored in the storage medium of the above embodiments, when loaded and executed by the processor of the computer, causes the computer to perform the method for outputting the character 100 as defined in any one of the above embodiments, and have the beneficial effects of the corresponding method embodiments, which is not be repeated here.

Those ordinary skilled in the art should understand that the discussion of any of the above embodiments is only exemplary, and is not intended to imply that the scope of the present disclosure (including the claims) is limited to these examples; under the thought of the present disclosure, the above embodiments or technical features in different embodiments may also be combined, the processes may be implemented in any order, and there are many other changes in different aspects of the present disclosure as described above, which are not provided in details for the sake of brevity.

In addition, to simplify the description and discussion, and not to make the present disclosure difficult to understand, the provided accompanying drawings may or may not show well-known power supply/ground connections with integrated circuit (IC) chips and other components. In addition, apparatuses may be shown in the form of block diagrams to avoid difficult understanding of the present disclosure, which also takes into account the fact that the details of implementations of the apparatuses in these block diagrams are highly dependent on a platform on which the present disclosure is implemented (that is, these details should be fully within an understanding scope of those skilled in the art). In the case that details (for example, circuits) are set forth to describe exemplary embodiments of the present disclosure, it is obvious for those skilled in the art that the present disclosure may be implemented without these details or with these details changed. Therefore, these descriptions should be considered illustrative rather than restrictive.

Although the present disclosure has been described in combination with the embodiments of the present disclosure, many substitutions, modifications, and variations of these embodiments are apparent to those ordinary skilled in the art based on the foregoing description. For example, other memory architectures, such as a dynamic RAM (DRAM), may use the discussed embodiments.

The present disclosure is intended to cover all such substitutions, modifications, and variations that fall within a broad scope of the appended claims. Therefore, within the spirit and principles of the present disclosure, any omissions, modifications, equivalent substitutions, improvements, and the like are within the protection scope of the present disclosure.

What is claimed is:

1. A method for outputting a character, comprising:
acquiring a character data stream;
acquiring a character picture by drawing character data in the character data stream based on a size of a target picture and a number of target characters contained in the target picture;
generating, according to a target display frequency, a character video based on the character picture; and
outputting the character video.

2. The method according to claim 1, wherein acquiring the character picture by drawing character data in the character data stream based on the size of the target picture and the number of target characters contained in the target picture comprises:
sequentially storing the character data stream in a target cache space;
sequentially extracting, according to a target extraction frequency, the character data in the character data stream in the target cache space; and
acquiring the character picture by drawing the character data according to a target drawing frequency based on the size of the target picture and the number of target characters contained in the target picture.

3. The method according to claim 2, wherein the target extraction frequency, the target drawing frequency, and the target display frequency are matched with one another, and values of the target extraction frequency, the target drawing frequency, and the target display frequency range from 20 to 40 frames/s.

4. The method according to claim 2, wherein sequentially storing the character data stream in the target cache space comprises:
allocating a target storage space to the target cache space, and sequentially storing the character data stream in the target storage space;
continuing to allocate, in response to a capacity of caching the character data stream exceeding a storage capacity of the target storage space, a first incremental storage space to the target cache space, and sequentially storing a part of the character data stream that exceeds the storage capacity in the first incremental storage space;
continuing to allocate, in response to the capacity of caching the character data stream exceeding a sum of storage capacities of the target storage space and the first incremental storage space, a second incremental storage space to the target cache space, and sequentially storing a part of the character data stream that exceeds the storage capacities of the target storage space and the first incremental storage space in the second incremental storage space; and
continuing to allocate an incremental storage space in response to the capacity of caching the character data stream exceeding the sum of the storage capacities of the target storage space and the allocated incremental storage space, and stopping, in response to a storage capacity of the storage space allocated to the target cache space reaching a storage capacity threshold, allocating an incremental storage space to the target cache space.

5. The method according to claim 4, wherein sequentially storing the character data stream in the target cache space further comprises:
allocating a preliminary storage space to the target cache space;
counting the character data in the character data stream in the preliminary storage space, and segmenting the character data according to a preset rule; and
sequentially storing the segmented character data in the target storage space.

6. The method according to claim 4, further comprising:
sequentially storing, in response to the storage capacity of the storage space allocated to the target cache space reaching the storage capacity threshold, the character data stream of a set ratio in the target cache space in another storage device.

7. The method according to claim 1, wherein acquiring the character picture by drawing character data in the character data stream based on the size of the target picture and the number of target characters contained in the target picture comprises:
determining the size of the target picture;
determining, based on the size of the target picture and a font size of a target character, the number of target characters contained in the target picture; and
drawing, according to a preset arrangement rule, the character data that are sequentially extracted on the target picture with the font size.

8. The method according to claim 7, wherein drawing, according to the preset arrangement rule, the character data that are sequentially extracted on the target picture with the font size comprises:
determining, according to the preset arrangement rule and the font size in combination with the size of the target picture, a target position of the character data on the target picture; and
drawing the character data at the target position on the target picture.

9. The method according to claim 1, wherein generating, according to the target display frequency, the character video based on the character picture comprises:
generating, with one of OpenCV and a multimedia processing tool, the character video based on the character picture according to the target display frequency.

10. The method according to claim 1, wherein outputting the character video comprises:
sending the character video to a real-time video service, to enable a display terminal to request to play the character video from the real-time video service.

11. The method according to claim 1, wherein the character data stream is a log data stream of a terminal device.

12. An electronic device, comprising:
at least one processor; and
a volatile or nonvolatile memory configured to store at least one instruction executable by the processor,
wherein the at least one processor, when executing the at least one instruction, is caused to perform:
acquiring a character data stream;
acquiring a character picture by drawing character data in the character data stream based on a size of a target picture and a number of target characters contained in the target picture;
generating, according to a target display frequency, a character video based on the character picture; and
outputting the character video.

13. The electronic device according to claim 12, wherein the at least one processor, when executing the at least one instruction, is caused to perform:
sequentially storing the character data stream in a target cache space;
sequentially extracting, according to a target extraction frequency, the character data in the character data stream in the target cache space; and
acquiring the character picture by drawing the character data according to a target drawing frequency based on the size of the target picture and the number of target characters contained in the target picture.

14. The electronic device according to claim 13, wherein the target extraction frequency, the target drawing frequency, and the target display frequency are matched with one another, and values of the target extraction frequency, the target drawing frequency, and the target display frequency range from 20 to 40 frames/s.

15. The electronic device according to claim 13, wherein the at least one processor, when executing the at least one instruction, is caused to perform:
allocating a target storage space to the target cache space, and sequentially storing the character data stream in the target storage space;
continuing to allocate, in response to a capacity of caching the character data stream exceeding a storage capacity of the target storage space, a first incremental storage space to the target cache space, and sequentially storing a part of the character data stream that exceeds the storage capacity in the first incremental storage space;
continuing to allocate, in response to the capacity of caching the character data stream exceeding a sum of storage capacities of the target storage space and the first incremental storage space, a second incremental storage space to the target cache space again, and sequentially storing a part of the character data stream that exceeds the storage capacities of the target storage space and the first incremental storage space in the second incremental storage space; and
continuing to allocate an incremental storage space in response to the capacity of caching the character data stream exceeding the sum of the storage capacities of the target storage space and the allocated incremental storage space, and stopping, in response to a storage capacity of the storage space allocated to the target cache space reaching a storage capacity threshold, allocating an incremental storage space to the target cache space.

16. A system for outputting a character, comprising:
an electronic device configured to acquire a character data stream; acquire a character picture by drawing character data in the character data stream based on a size of a target picture and a number of target characters contained in the target picture; generate, according to a target display frequency, a character video based on the character picture; and output the character video;
a terminal device configured to output the character data stream to the electronic device; and
a display apparatus configured to display the character video output by the electronic device.

17. The system according to claim 16, wherein the electronic device is further configured to:
sequentially store the character data stream in a target cache space;
sequentially extract, according to a target extraction frequency, the character data in the character data stream in the target cache space; and
acquire the character picture by drawing the character data according to a target drawing frequency based on the size of the target picture and the number of target characters contained in the target picture.

18. The system according to claim 17, wherein the target extraction frequency, the target drawing frequency, and the target display frequency are matched with one another, and values of the target extraction frequency, the target drawing frequency, and the target display frequency range from 20 to 40 frames/s.

19. The system according to claim 17, wherein the electronic device is further configured to:
allocate a target storage space to the target cache space, and sequentially store the character data stream in the target storage space;
continue to allocate, in response to a capacity of caching the character data stream exceeding a storage capacity of the target storage space, a first incremental storage space to the target cache space, and sequentially store a part of the character data stream that exceeds the storage capacity in the first incremental storage space;
continue to allocate, in response to the capacity of caching the character data stream exceeding a sum of storage capacities of the target storage space and the first incremental storage space, a second incremental storage space to the target cache space again, and sequentially store a part of the character data stream that exceeds the storage capacities of the target storage space and the first incremental storage space in the second incremental storage space; and
continuing to allocate an incremental storage space in response to the capacity of caching the character data stream exceeding the sum of the storage capacities of the target storage space and the allocated incremental storage space, and stop, in response to a storage capacity of the storage space allocated to the target cache space reaching a storage capacity threshold, allocating an incremental storage space to the target cache space.

20. A non-transitory computer-readable storage medium storing at least one instruction therein, wherein the at least one instruction, when loaded and executed by a processor of an electronic device, causes the electronic device to perform the method for outputting the character as defined in claim 1.
